(19) United States
(12) Patent Application Publication
(10) Pub. No.: US 2014/0091244 A1
(43) Pub. Date: Apr. 3, 2014

(54) DEVICE FOR TRANSFERRING A LIQUID

(71) Applicant: OIL SYSTEM, Paris (FR)

(72) Inventor: Yves GRICOURT, MONTBELLET (FR)

(73) Assignee: OIL SYSTEM, Paris (FR)

(21) Appl. No.: 14/043,429

(22) Filed: Oct. 1, 2013

(30) Foreign Application Priority Data
Oct. 2, 2012 (FR) 12 59326

(51) Int. Cl. F16L 29/00

(52) U.S. Cl. CPC F16L 29/00
USPC 251/148

(57) ABSTRACT

A liquid-transfer device that comprises a tubular coupling element for fastening in sealed manner to a liquid-transfer orifice and including a bore extending through the coupling element, and a valve member mounted to slide in the coupling element between a closed position for closing the coupling element and a liquid-transfer position for transferring liquid through the coupling element. The valve member is slidable against a return spring urging it towards the closed position and being suitable for sliding from the closed position to the liquid-transfer position under the action of an adapter that is reversibly connectable to the coupling element. One coupling element and the adapter includes a set of longitudinal grooves and the other includes radial teeth that engage in the grooves while the adapter is being actuated, the coupling element having an abutment against which the adapter bears after the valve member has been actuated by the adapter.

In general terms, the invention relates to transferring liquids, in particular by gravity, by pumping, or under the effect of a pressure difference. More particularly, in a particularly advantageous application, the invention relates to plugs for fastening to the drain orifices of the crankcases of motor vehicles and of machine tools.

In order to facilitate draining such crankcases, numerous solutions have been proposed for reducing the manipulations to be performed on the plug and consequently for reducing the time required for draining.

Such a plug is designed to be screwed into an orifice in a crankcase and it includes a movable valve member for closing the plug and suitable for being moved in translation by means of an appropriate device, in particular an adapter that is mounted on the end of a draining pipe. Once installed in the plug, the adapter causes the valve member to penetrate into the inside of the crankcase, or in more general terms of the container, thereby releasing the drain orifice in order to drain out the liquid, and in particular oil.

By way of example, such a plug is described in document FR 2 773 365.

The plug described in that document comprises a plug body with a radial skirt situated at between one-third and one-half of the height of the body for the purpose of coming to bear against the wall of the crankcase when the plug is screwed home.

In the mounted state, the body defines a projecting extension that has an annular groove for use in fastening the adapter.

Internally, the plug defines a bore in which the valve member is mounted.

A set of gaskets are provided inside the internal bore of the body of the plug with the valve member bearing against them in the open position of the plug and also in its closed position.

That type of organization suffers from certain drawbacks.

Firstly, it has been found that the plug body, constituting a coupling element of the device, projects out from the tank and then runs the risk of being damaged.

Secondly, the device is screwed to the container using a flat key.

Thirdly, the gasket facing towards the outside of the container is unprotected and therefore runs the risk of being damaged.

Finally, it is observed that the plug is made as a single piece, which means that it cannot be made out of different materials.

The object of the invention is thus to mitigate some or all of the above-mentioned drawbacks.

To this end, the invention provides a device for transferring a liquid, the device comprising a tubular coupling element for fastening in sealed manner to a liquid-transfer orifice and including a bore extending through the coupling element, and a valve member mounted to slide in the coupling element between a closed position for closing the coupling element and a liquid-transfer position for transferring liquid through the coupling element, the valve member being slidable against a return spring urging it towards the closed position and being suitable for sliding from the closed position to the liquid-transfer position under the action of an adapter that is reversibly connectable to the coupling element.

In addition, one of the tubular coupling and the adapter includes a set of longitudinal grooves and the other includes radial teeth that engage in the grooves while the adapter is being actuated, the coupling element having an abutment against which the adapter bears after the valve member has been actuated by the adapter.

In an embodiment, the coupling element includes a set of longitudinal grooves formed in its inside peripheral surface for the purpose of receiving radial teeth provided on the adapter, said grooves defining the abutment on which said teeth bear after the valve member has been actuated by the adapter.

Advantageously, the end of the tubular coupling element including the abutment has indentations suitable for preventing the radial teeth from turning after the valve member has been actuated.

According to another characteristic of the invention, the coupling element has a body with an outside thread for co-operating with a corresponding thread provided in the fluid-transfer orifice, and includes a bore in which the longitudinal grooves are formed, said bore having a section of polygonal shape suitable for receiving a polygonal driver tool for the plug.

For example, the longitudinal grooves are provided at the corners of said polygonal shape.

Provision may be made for the bore to be hexagonal and to include a set of three grooves or of six grooves.

In an embodiment, the tubular coupling element includes a base in which said longitudinal grooves are formed and defining said abutment, the base being fastened to the coupling element by adhesive or by welding.

The base can thus be made of a material that is different from the material of the remainder of the plug.

Advantageously, in an embodiment, when the transfer device is mounted on a container, the tubular coupling element is flush with the surface of the container.

According to yet another characteristic of the invention, the valve member comprises a valve member having a first end provided with a first shoulder fitted with a first sealing gasket that bears against the abutment in the closed position and that constitutes a surface for actuating the valve member, and a second end that is provided with a second sealing gasket that bears against the tubular coupling element in the closed position of the valve member.

It should be observed that the first gasket is set back relative to the free end of the coupling element that is to receive the adapter.

Advantageously, a resin is arranged around the tubular coupling element at the location where it is mounted on the container.

According to yet another characteristic of the invention, the device further includes an adapter comprising an adapter body for coupling to a liquid-transfer pipe, a coupling tube mounted on the body and provided with radial end teeth, and a cover mounted to be axially movable relative to the body against a return spring between a stable, deployed position in which it covers the coupling tube and an unstable position that is retracted relative to the body, thereby making the coupling tube accessible.

Other objects, characteristics, and advantages of the invention appear on reading the following description given purely by way of non-limiting example and made with reference to the accompanying drawings, in which:

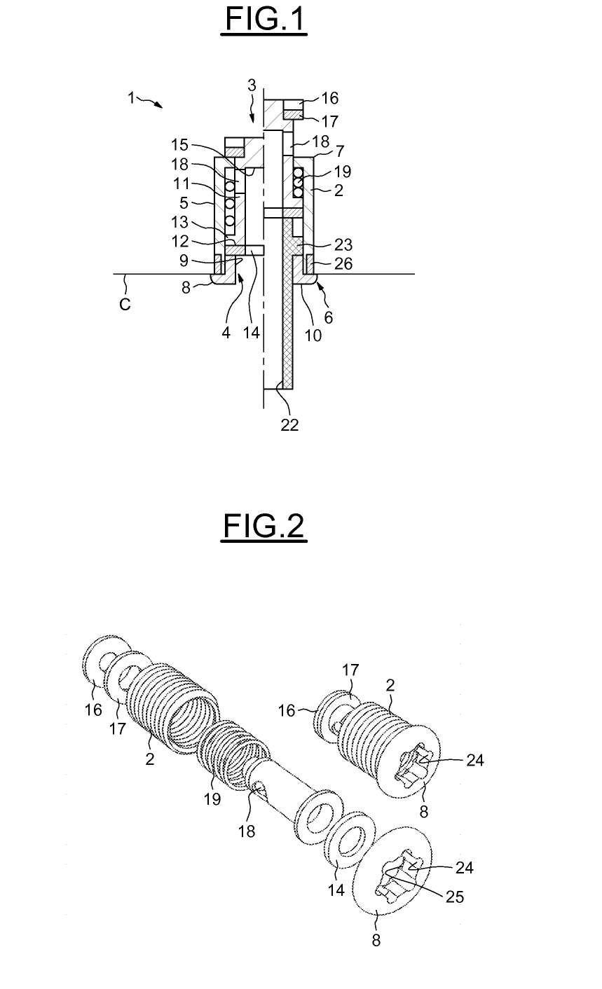

FIG. 1 is an axial section view of a coupling element of a transfer device in accordance with the invention, showing the valve member in its closed position and in its liquid-transfer position;

FIG. 2 is an exploded view of the FIG. 1 coupling element;

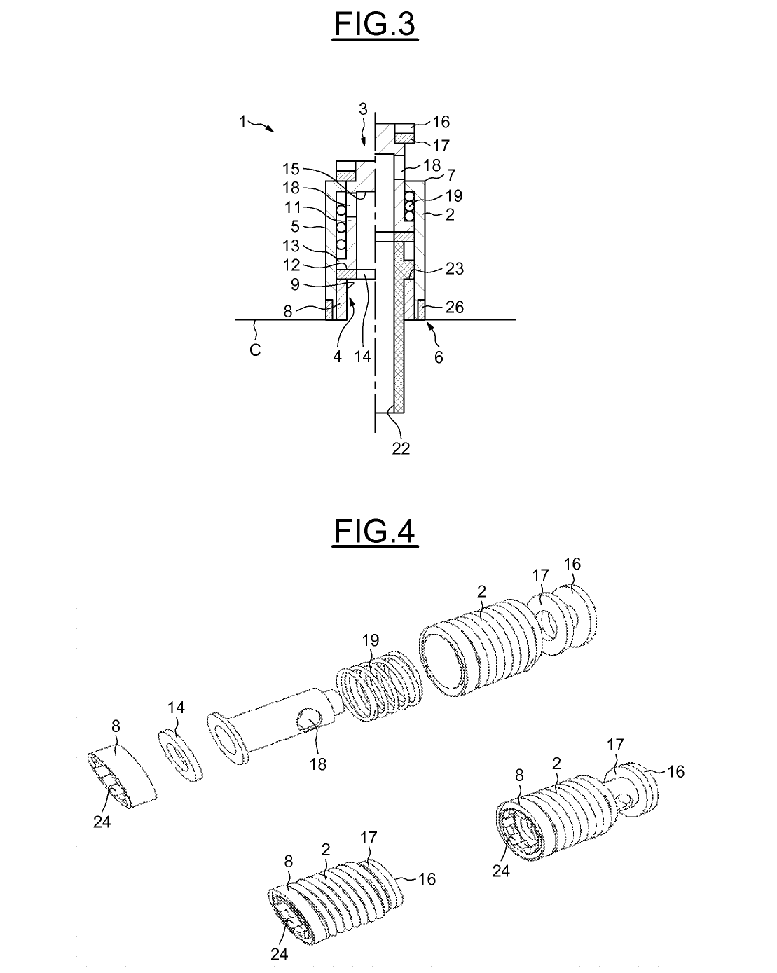

FIG. 3 shows another embodiment of a tubular coupling element of a transfer device of the invention;

FIG. 4 is an exploded view of the FIG. 3 coupling element;

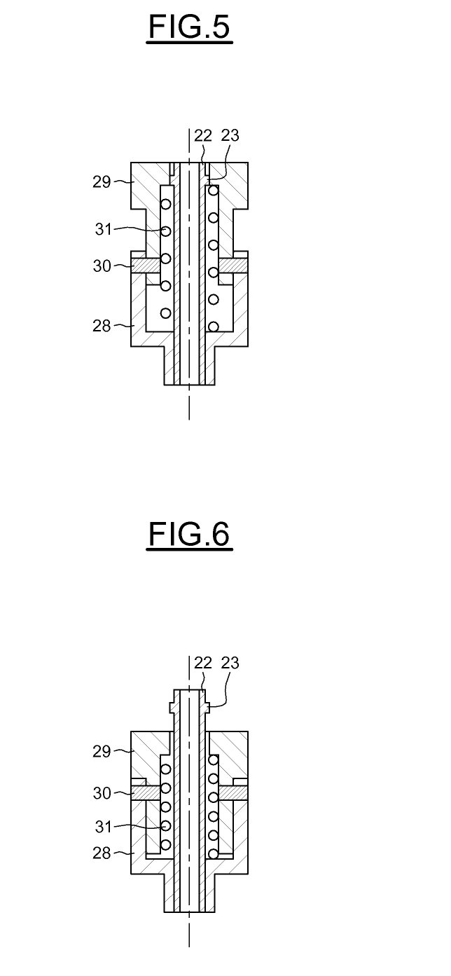

FIGS. 5 and 6 are axial views of an adapter of a liquid-transfer device in accordance with the invention, shown respectively in a stable, deployed position and an unstable, retracted position;

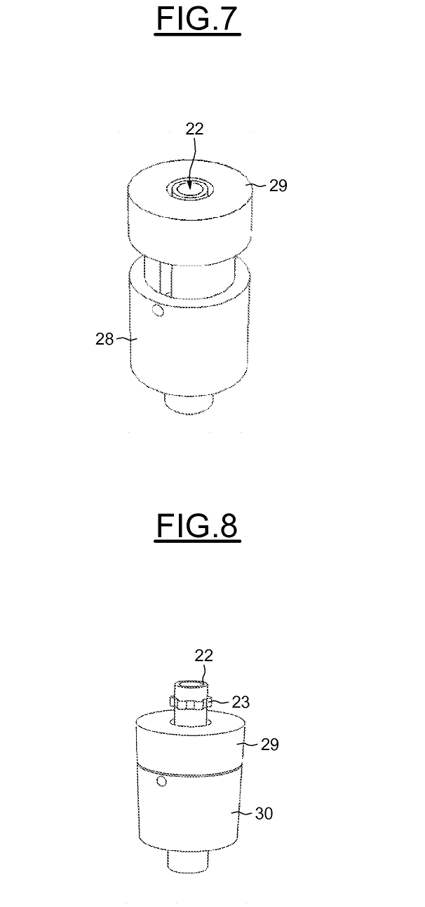

FIGS. 7 and 8 are perspective views of the adapter of FIGS. 5 and 6, respectively in the stable, deployed position and in the unstable, retracted position of the cover; and

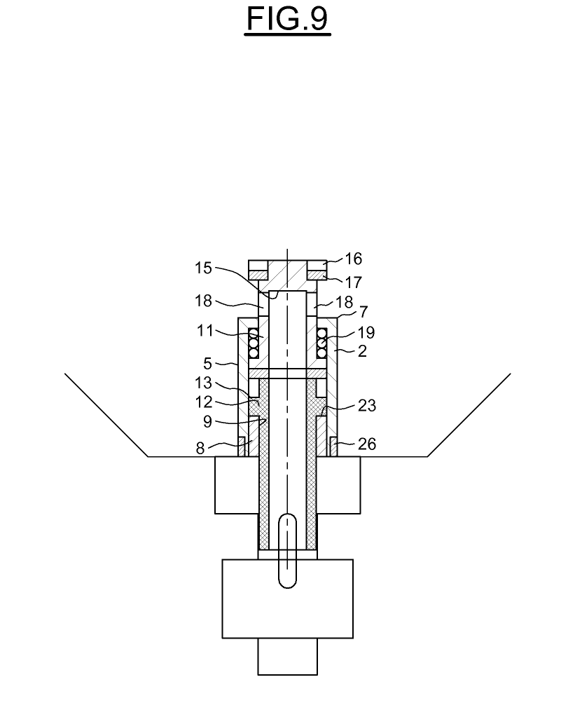

FIG. 9 is a diagram of an adapter mounted on a tubular coupling element.

With reference to FIGS. 1 and 2, the description begins with a first embodiment of a tubular coupling element of a liquid-transfer device in accordance with the invention.

In the embodiment in question, the liquid-transfer device is for draining crankcases of motor vehicles or of machine tools.

Under such circumstances, the tubular coupling element visible in FIGS. 1 and 2 constitutes a plug that is fastened by being screwed into the drain orifice of a crankcase C.

As can be seen in FIG. 1, the tubular coupling element, referred to below as a “plug”, is given an overall numerical reference 1 and is fundamentally made up of two portions, namely a plug body 2 and a valve member 3 that is suitable for moving in translation within a bore 4 formed within the body 2.

Since the plug is for fastening in the drain orifice of a motor vehicle crankcase, its body presents an outside thread 5 corresponding to the diameter and the pitch of the tapping in the drain orifice of the crankcase.

As can be seen, the body 2 is tubular in shape having a first end 6 whereby it bears against the wall of the crankcase, and an opposite end 7 that faces towards the inside of the tank and that has an axial passage allowing the valve member 3 to pass when transferring liquid, as described in detail below.

In FIG. 1, it can also be seen that in this embodiment the plug 1 has a separate base 8 that is fastened to the first end 6 of the plug body by adhesive or by welding.

For this purpose, the base 8 has an annular skirt 9 that is inserted in the plug body 5 and an end head 10 that comes to bear against the outside surface of the crankcase C.

Overall, the plug including the base 8 presents circular symmetry.

The valve member 3 is slidably mounted inside the plug 1, and in particular in the plug body 5 to move between a closed position for closing the plug, shown on the left-hand side of FIG. 1, and a liquid-transfer position for transferring liquid through the plug, shown on the right-hand side of FIG. 1.

In this respect, the valve member comprises a valve body 11 having a first end 12 pointing towards the outside of the crankcase and defining a first shoulder 13 extending radially outwards and fitted with a first sealing gasket 14, and a closed opposite end 15 having an end washer 16 supporting a second sealing gasket 17 that comes to bear against the second end 7 of the plug body 5 when the valve member is in its first position.

In FIG. 1, it can also be seen that the valve body 11 is provided with radial ports such as 18 that are positioned in such a manner as to be located in the inside volume of the plug body 5 when the valve member is in its closed, first position, and to extend out from the plug body 5 when the valve member is in its liquid-transfer, second position.

The assembly also has a return spring 19 placed to bear against the plug body 5 and the radial shoulder 15 in order to urge the valve member into its closed, first position.

In this closed position, the gaskets 14 and 17 bear respectively against the skirt 9 of the base 8 and against the outside surface of the plug body 5.

It should be observed that there are two ports, by way of example. Naturally, this number may be varied in any way, the result to be achieved being to provide a sufficient passage between the inside of the valve member and the outside.

The valve member is moved from the closed, first position to the fluid-transfer, second position by means of a tool, and in particular by means of an adapter mounted on the end of a draining pipe that is reversibly coupled to the plug throughout the operation of transferring liquid.

In this respect, the adapter has a coupling tube 22 provided with radial teeth such as 23.

In the bore 4, the base 8 has an indentation, or more generally a housing, in which a certain number of longitudinal grooves 24 are formed enabling the teeth 23 of the coupling tube to pass when the adapter is properly oriented relative to the plug.

Thus, in order to move the valve member from the closed, first position to the liquid-transfer, second position, it suffices merely to exert force on the coupling tube 22 of the adapter. During this movement of the coupling tube 22, the teeth 23 are inserted into the longitudinal groove 24 in the base 8 until they have gone beyond the adapter.

In this position, the free end of the skirt 9 of the base 8 constitutes an abutment against which the teeth 23 can rest after the coupling tube 22 has been caused to turn.

In this position, by bearing against its abutment, the coupling tube 22 holds the valve member in the liquid-transfer position against the force exerted by the return spring 19, and the port 18 provides communication between the inside of the crankcase C and the coupling tube 22 of the adapter in order to drain the crankcase C.

In this respect, it should be observed that the end of the base, i.e. the free end of the skirt 9, is provided with a certain number of radial indentations 25 against which the teeth 23 come to bear (FIG. 2), these indentations being made in the form of notches shaped so as to prevent the teeth 23 from turning after the valve member has been actuated.

In the embodiment described with reference to

FIGS. 1 and 2, which is appropriate for transfer devices and in particular for plugs having a diameter of 12 millimeters (mm), the plug body 5 has a base 8 that is separate and fitted, bonded or welded to the body 5.

This embodiment is advantageous insofar as the base can then be made of a material other than the material used for making the plug body 5. In this respect, the base may be made using a metal injection molding (MIM) method, by hot or cold die stamping, by sintering metal powder, or by machining. In this respect the entire plug assembly may also be made out of plastics material.

Thus, the base may be made out of steel that is very hard and very strong.

As mentioned above, the base may be fastened by adhesive or by welding. It is advantageous to use laser welding, thus making it possible to weld the rubber gaskets without damaging them.

It should also be observed that in the above-described transfer device, it is advantageous to use resin 26 arranged around the plug body 5 where it is mounted on the container in order to contribute to the retention and the sealing of the plug.

In the embodiment of FIG. 3, which is appropriate for diameters of more than 14 mm, the plug body 5 does not have a separate base that extends beyond the outside of the crankcase.

In fact, in this embodiment, in which elements that are identical to elements described above with reference to FIGS. 1 and 2 are given the same numerical references, a cylindrical base 8 is used that is mounted entirely inside the plug body 5 so as to be flush with the crankcase once the plug has been screwed home therein.

This embodiment is thus particularly advantageous insofar as no element of the plug projects out from the crankcase.

Naturally, in this embodiment, the circular base 8 is likewise provided with longitudinal grooves 24 for enabling the coupling tube 22 to be inserted and thus causing the valve member to be actuated, together with indentations for holding the teeth against turning.

It should be observed that in both embodiments, the base 8 is also provided with a bore defining a polygonal housing that is shaped so as to receive a tightening tool such as an Allen key.

Under such circumstances, the longitudinal grooves are advantageously provided at the corners of the polygonal bore.

In the embodiment shown in the figures, the base may have six longitudinal grooves and one hexagonal housing.

Naturally, it would not go beyond the ambit of the invention to adopt more generally any polygonal shape with any number of longitudinal grooves, e.g. three or six grooves.

It should be observed that the embodiment of FIG. 3 is advantageous insofar as no elements project from the crankcase, where such a projecting element would run the risk of damaging the plug or the crankcase by catching on some other item.

Finally, it should be observed that in the embodiment of FIGS. 1 to 3, it is advantageous to provide for a separate plug that is magnetic and that is positioned in such a manner as to close the zone of the plug that is accessible from the outside so as to avoid dirt or particles harming the plug or indeed preventing proper operation of the valve member.

FIGS. 5 to 8 show that the adapter suitable for use with the plug described above with reference to

FIGS. 1 and 3 essentially comprises an adapter body 28 fastened to the end of a suction tube (not shown) and having the coupling tube 22 with its radial end teeth 23 mounted thereon.

The adapter also has a cover 29 that is axially movable relative to the adapter body 28 between a ready position, shown in FIG. 5, in which the cover 29 extends all the way around the coupling tube 22, and a retracted, active position, shown in FIG. 6, in which the cover 29 releases the coupling tube 22 in order to enable it to be coupled to the above-described plug 1.

In this respect, it should be observed that the cover 29 has radial pegs 30 that slide in slots (not shown) formed in the adapter body 28 in order to guide it. A spring 31 urges the cover 29 towards its rest, first position.

With reference now to FIG. 9, in order to use the above-described device, it suffices merely to present the adapter provided at the end of a suction tube to a plug 1 of a crankcase and to exert a force firstly to retract the cover 29 so as to release the coupling tube 22 and secondly so as to insert the coupling tube through the base 8 so as to exert a thrust force on the valve member until it takes up its fluid-transfer position.

It then suffices merely to turn the coupling tube 22 so as to position the teeth 23 in abutment against the base 8.

Finally, it should be observed that the above-described embodiment applies to draining a crankcase, in particular of a motor vehicle engine.

Nevertheless, in more general manner, it would not go beyond the ambit of the invention to provide hydraulic coupling, in particular between a tank and a coupling pipe of the tank or a pipe coupling by using a liquid-transfer device having a coupling element mounted on one of the elements that are to be coupled together and provided internally with a valve member, and an adapter provided with a coupling tube mounted at the end of another pipe for coupling.

1. A device for transferring a liquid, the device comprising:
a tubular coupling element for fastening in sealed manner to a liquid-transfer orifice and including a bore extending through the coupling element, and
a valve member mounted to slide in the coupling element between a closed position for closing the coupling element and a liquid-transfer position for transferring liquid through the coupling element, the valve member being slidable against a return spring urging it towards the closed position and suitable for sliding from the closed position to the liquid-transfer position under the action of an adapter that is reversibly connectable to the coupling element,
wherein one of the tubular coupling and the adapter includes a set of longitudinal grooves and the other tubular coupling includes radial teeth that engage in the grooves while the adapter is being actuated, and
wherein the coupling element has an abutment against which the adapter bears after the valve member has been actuated by the adapter.

2. A device according to claim 1, characterized in that the valve member is slidably mounted in the bore to slide between the closed position for closing the coupling element and the liquid-transfer position, and in that the abutment is arranged inside said bore.

3. A device according to claim 1, characterized in that the tubular coupling element includes a set of longitudinal grooves formed in its inside peripheral surface for the purpose of receiving radial teeth provided on the adapter, said grooves defining the abutment on which said teeth bear after the valve member has been actuated by the adapter.

4. A device according claim 1, characterized in that the end of the tubular coupling element including the abutment has indentations suitable for preventing the radial teeth from turning after the valve member has been actuated.

5. A device according to claim 3, characterized in that the coupling element has a body with an outside thread for co-operating with a corresponding thread provided in the fluid-transfer orifice, and includes a bore in which the longitudinal grooves are formed, said bore having a section of polygonal shape suitable for receiving a polygonal driver tool for the coupling element.

6. A device according to claim 5, characterized in that the longitudinal grooves are provided at the corners of said polygonal shape.

7. A device according to claim 5, characterized in that the bore is hexagonal and has a set of three grooves or of six grooves.

8. A device according claim 3, characterized in that the tubular coupling element includes a base in which said longitudinal grooves are formed and defining said abutment, the base being fastened to the coupling element by adhesive or by welding.

9. A device according to claim 8, characterized in that the base is made of a material that is different from the material of the remainder of the plug.

10. A device according to claim 8, characterized in that the coupling element includes a body having the bore formed therein, the base including an annular skirt inserted in said body and having said longitudinal grooves formed therein, a free end of the annular skirt defining the abutment.

11. A device according to claim 1, characterized in that when the transfer device is mounted on a container, the coupling element is flush with the surface of the container.

12. A device according to claim 1, characterized in that the valve member comprises a valve member having a first end provided with a first shoulder fitted with a first sealing gasket that bears against the abutment in the closed position and that constitutes a surface for actuating the valve member, and a second end that is provided with a second sealing gasket that bears against the tubular coupling element in the closed position of the valve member.

13. A device according to claim 12, characterized in that the first gasket is set back relative to the free end of the coupling element that is to receive the adapter.

14. A device according to claim 1, characterized in that a resin is arranged around the tubular coupling element at the location where it is mounted on the container.

15. A device according to claim 1, characterized in that it further includes an adapter comprising an adapter body that is to be coupled to a liquid-transfer pipe, a coupling tube mounted on the body and provided with radial teeth or longitudinal grooves, the coupling tube being configured both to cause the valve member to move from the closed position to the liquid-transfer position, and to come to bear against the abutment in order to hold the valve member in the liquid-transfer position.

16. device according to claim 3, characterized in that it further includes an adapter comprising an adapter body for coupling to a liquid-transfer pipe, a coupling tube mounted on the body and provided with radial end teeth, and a cover mounted to be axially movable relative to the body against a return spring between a stable, deployed position in which it covers the coupling tube and an unstable position that is retracted relative to the body, thereby making the coupling tube accessible.
